(19) United States
(12) Patent Application Publication
(10) Pub. No.: US 2015/0237338 A1
(43) Pub. Date: Aug. 20, 2015

(54) FLIP-UP STEREO VIEWING GLASSES

(71) Applicant: AUTODESK, Inc, San Rafael, CA (US)

(72) Inventors: Tovi GROSSMAN, Toronto (CA); George FITZMAURICE, Toronto (CA); Natalia BOGDAN, (US)

(21) Appl. No.: 14/622,770

(22) Filed: Feb. 13, 2015

Related U.S. Application Data
(60) Provisional application No. 61/940,246, filed on Feb. 14, 2014.

(51) Int. Cl. H04N 13/04

(52) U.S. Cl. CPC H04N 13/0454; H04N 13/0434; H04N 2213/001; H04N 2213/008

(57) ABSTRACT

An apparatus for viewing a stereoscopic display comprises a frame chassis, a hinge mechanism, a left lens assembly, a right lens assembly, and a sensor array. The hinge mechanism allows the left lens assembly and the right lens assembly to switch from a first orientation to a second orientation. The left lens assembly is coupled to the frame chassis via the hinge mechanism and is configured to be transparent to a first image output by the stereoscopic display and opaque to a second image output from the stereoscopic display, while the right lens assembly is coupled to the frame chassis via the hinge mechanism and is configured to be transparent to the second image output and opaque to the first image output. The sensor array is positioned to detect a current orientation of the left lens and the right lens.

### CROSS-REFERENCE TO RELATED APPLICATIONS

This application claims benefit of the U.S. Provisional Patent Application having Ser. No. 61/940,246 (Attorney Docket Number AUTO/1317USL) and filed on Feb. 14, 2014. The subject matter of this related application is hereby incorporated herein by reference.

### BACKGROUND OF THE INVENTION

1. Field of the Invention

The present invention relates generally to viewing content presented by a stereoscopic display and, more specifically, to flip-up stereo viewing glasses.

2. Description of the Related Art

Digitally displayed technology has advanced to the point where content can be readily displayed stereoscopically to the viewer. This is true not only for large-scale projection, as in movie theaters, but also for computer and television displays. Such displays, used in conjunction with suitably configured 3D stereo viewing eyeglasses, allow a viewer to view content on a computer or television in what appears to be three dimensions (3D), either for an enhanced viewing experience or to better facilitate viewer interaction with an application that presents content in 3D. However, viewing content in 3D stereo is not always desirable. For example, one may preferably view a 3D movie or a 3D model displayed by a modeling application in 3D, but emails or other 2D content in 2D.

When switching from 3D to 2D content, a viewer may choose to continue wearing the 3D stereo eyeglasses for convenience. However, the eyeglasses may partially occlude the viewer's field of view or otherwise be distracting to the viewer. For example, continuing to wear 3D stereo eyeglasses while viewing 2D content can significantly darken the 2D image, since 3D stereo eyeglasses generally filter half of the output from a display screen via polarization or color filtering. Alternatively, a viewer may remove the 3D stereo eyeglasses whenever viewing 2D content, a process that can be cumbersome when switching between 2D and 3D content frequently.

As the foregoing illustrates, there is a need for a more effective way to switch between viewing 2D content and 3D content presented by a stereoscopic display device.

### SUMMARY OF THE INVENTION

One embodiment of the present invention sets forth an apparatus for viewing a stereoscopic display, the apparatus comprising a frame chassis, a hinge mechanism, a left lens assembly, a right lens assembly, and a sensor array. The hinge mechanism allows the left lens assembly and the right lens assembly to switch from a first orientation to a second orientation. The left lens assembly is coupled to the frame chassis via the hinge mechanism and is configured to be transparent to a first image output by the stereoscopic display and opaque to a second image output from the stereoscopic display, while the right lens assembly is coupled to the frame chassis via the hinge mechanism and is configured to be transparent to the second image output and opaque to the first image output. The sensor array is positioned to detect a current orientation of the left lens and the right lens.

One advantage of the disclosed stereo-viewing glasses is that switching between viewing 2D content and 3D content can be effected without removal of the stereo-viewing glasses.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically illustrates a spectroscopic display system configured to implement one or more aspects of the present invention.

FIG. 2A schematically illustrates a plan view of the flip-up stereo viewing glasses of the system in FIG. 1 in a 3D viewing orientation, according to one embodiment of the present invention.

FIG. 2B schematically illustrates a side view of the flip-up stereo viewing glasses of the system in FIG. 1 in a 3D viewing orientation, according to one embodiment of the present invention.

FIG. 3A schematically illustrates a plan view of the flip-up stereo viewing glasses of the system in FIG. 1 in a 2D viewing orientation, according to one embodiment of the present invention.

FIG. 3B schematically illustrates a side view of the flip-up stereo viewing glasses of the system in FIG. 1 in a 2D viewing orientation, according to one embodiment of the present invention.

### DETAILED DESCRIPTION OF EXEMPLARY EMBODIMENTS

In the following description, numerous specific details are set forth to provide a more thorough understanding of the present invention. However, it will be apparent to one of skill in the art that the present invention may be practiced without one or more of these specific details.

As used herein, the term “3D content” refers to visual matter, such as images and video content, that are presented stereoscopically to a viewer, i.e., via dual two-dimensional images, each image being presented to a different eye of the viewer. Thus, “3D content” generally includes images having simulated depth, and does not refer to images displayed in three full dimensions, such as that generated by a holographic display or volumetric display. Similarly, the terms “3D display,” “3D projection,” and the like, as used herein, refer to stereoscopic display and stereoscopic projection techniques that simulate a three dimensional visual experience for a viewer, and do not generally imply full three-dimensional image generation.

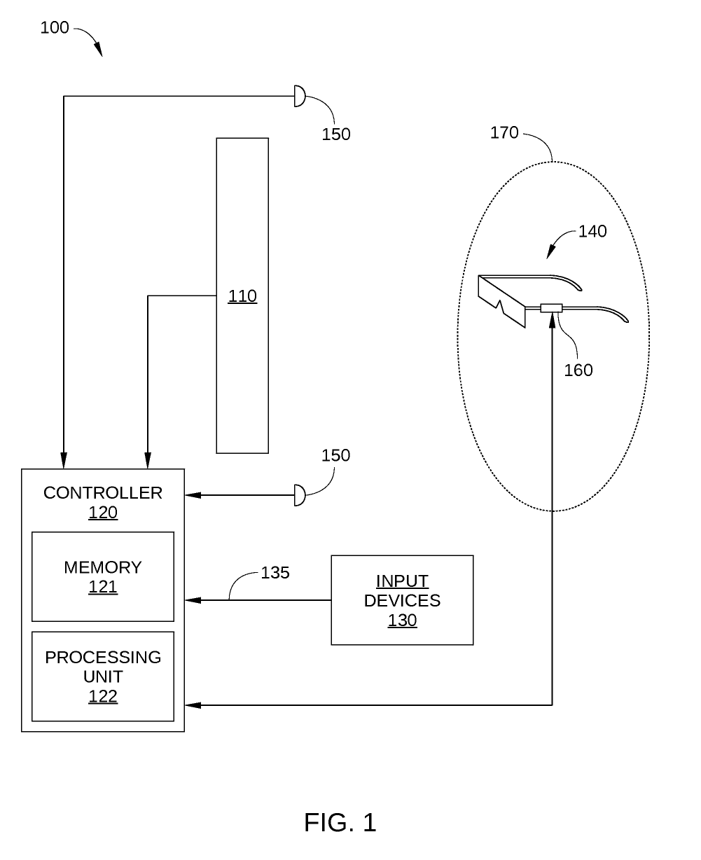

FIG. 1 schematically illustrates a stereoscopic display system 100 configured to implement one or more aspects of the present invention. 3D display system 100 may be a commercial or home 3D (stereoscopic) projection system, an arcade or home video system, a 3D (stereoscopic) television, computer-aided design system, computer work station, or any other device or system suitable for practicing one or more embodiments of the present invention. Generally, stereoscopic display system 100 is configured to selectively display 2D and 3D content to a viewer, such as graphical images and/or videos, and includes a display device 110, a controller 120, input devices 130, flip-up stereo viewing glasses 140 positioned in a viewing region 170 of display device 110, and, in some embodiments, one or more orientation sensors 150 and/or a wireless communication module 160. It is noted that stereoscopic display system 100 described herein is illustrative and that any other technically feasible configurations thereof fall within the scope of the present invention. For example, one or more of the above components may be combined into a single apparatus, omitted, or duplicated.

Display device 110 may be any technically feasible video display device, screen, projector and projection surface system, or monitor capable of conveying depth perception to a viewer via stereoscopy, i.e., by presenting two offset images separately to the left and right eye of the viewer. For example, in some embodiments, display device 110 is a computer monitor configured to present a first image output of particular subject matter to a viewer's left eye and a second image output of the subject matter to the viewer's right eye. Because the first image output is offset from the second image output, the viewer experiences simulated depth of field via stereoscopy. Generally, stereoscopy is effected in stereoscopic display system 100 by the viewer wearing flip-up stereo viewing glasses 140, which are configured to prevent the first image output from reaching the viewer's right eye and the second image output from reaching the viewer's left eye. Flip-up stereo viewing glasses 140 are described in greater detail below.

Suitable technologies that may be implemented in display device 110 to enable stereoscopic viewing include active polarization shutter systems (e.g., liquid crystal shutter glasses), passive polarization systems, where each lens allows light of one polarization and blocks light of orthogonal polarization, interference filter systems, which use specific wavelengths of red, green, and blue for the right eye, and different wavelengths of red, green, and blue for the left eye, color anaglyph systems, chromadepth systems, and the like.

Controller 120 is configured to control operation of stereoscopic display system 100, including receiving commands and/or data from input devices 130 and transmitting data to display device 110. Controller 120 may be or include a desktop computer, laptop computer, smart phone, personal digital assistant (PDA), video game console, set top console, tablet computer, digital video recorder, digital video disk player, or any other type of computing device suitable for controlling stereoscopic display system 100 to display graphical images and/or videos to a viewer. In some embodiments, controller 120 may be configured to generate some or all 2D or 3D content displayed by stereoscopic display system 100. For example, controller 120 may be configured to run a modeling application or video game. Generally, controller 120 includes a memory 121 and a processing unit 122.

Memory 121 may include volatile memory, such as a random access memory (RAM) module, and non-volatile memory, such as a flash memory unit, a read-only memory (ROM), or a magnetic or optical disk drive, or any other type of memory unit or combination thereof. Memory 121 is configured to store any software programs, operating system, drivers, and the like, that facilitate operation of stereoscopic display system 100. Processing unit 122 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 122 may be any technically feasible hardware unit capable of processing data and/or executing software applications to facilitate operation of stereoscopic display system 100.

Input devices 130 may include devices capable of providing input to controller 120, such as a keyboard, a mouse, a touchscreen, a television remote control, a video game console, and the like. Input devices 130 may communicate with controller 120 via a wired or wireless connection 135, such as Bluetooth or infrared signals. In some embodiments, input devices 130 may include a connection to any technically feasible type of communications or information network that allows data to be exchanged between controller 120 and input devices 130, such as a wide area network (WAN), a local area network (LAN), a wireless (WiFi) network, and/or the Internet, among others.

Orientation sensors 150 may include any devices configured to detect the orientation of flip-up stereo viewing glasses 140 and transmit orientation data to controller 120. Alternatively, orientation sensors 150 may include devices configured to image flip-up stereo viewing glasses 140 and to transmit image data to controller 120. In such embodiments, controller 120 may be configured to determine the current orientation (e.g., 2D viewing orientation or 3D viewing orientation) of flip-up stereo viewing glasses 140 based on such image data. In some embodiments, orientation sensors 150 include two or more digital video cameras positioned within line-of-sight of flip-up stereo viewing glasses 140.

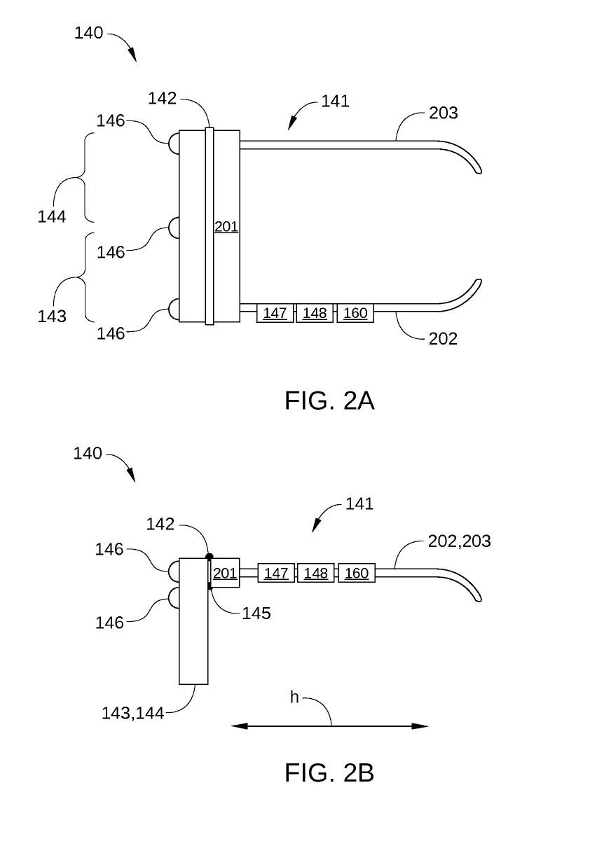

Wireless communication module 160 is configured to transmit information to and receive information from controller 120 and/or display device 110, and may be any technically feasible wireless communication apparatus suitable for such. For example, wireless communication module 160 may include a Bluetooth transceiver, an infrared transceiver, or a combination of both. In some embodiments, described below in conjunction with FIGS. 2A and 2B, flip-up stereo viewing glasses 140 may include active components configured to respond to a change in the current display mode of display device 110, or display device 110 may be configured to change the current display mode in response to a change in orientation of flip-up stereo viewing glasses 140. In such embodiments, wireless communication module 160 facilitates communication between flip-up stereo viewing glasses 140 and either controller 120 or display device 110. Alternatively, in such embodiments, a wired connection may be used in lieu of wireless communication module 160.

FIG. 2A schematically illustrates a plan view of flip-up stereo viewing glasses 140 in a 3D viewing orientation, according to various embodiments of the present invention. FIG. 2B schematically illustrates a side view of flip-up stereo viewing glasses 140 in a 3D viewing orientation, according to various embodiments of the present invention. As shown, flip-up stereo viewing glasses 140 include a frame chassis 141, a hinge mechanism 142 mounted on and/or contained within frame chassis 141, a left lens assembly 143 and a right lens assembly 144 each coupled to hinge mechanism 142, and a sensor array 145. In some embodiments, flip-up stereo viewing glasses 140 may also include orientation markers 146 positioned at various locations on flip-up stereo viewing glasses 140, an actuator controller 147, and a power source 148.

Frame chassis 141 forms the structural framework of flip-up stereo viewing glasses 140. Thus, frame chassis 141 supports left lens assembly 143 and right lens assembly 144, and provides components that facilitate the wearing of flip-up stereo viewing glasses 140 by a viewer. Frame chassis 141 includes a bridge 201 with a left extension arm 202 coupled to one end of bridge 201 and a right extension arm 203 coupled to an opposite end of bridge 201. Left extension arm 202 and right extension arm 203 each extend rearward from bridge 201 (i.e., away from the viewing direction of a viewer wearing flip-up stereo viewing glasses 140), and are configured to comfortably engage the sides and/or ears of a viewer's head. In some embodiments, left extension arm 202 and right extension arm 203 are each coupled to bridge 201 with a respective hinge, similar to conventional eyeglasses or sunglasses.

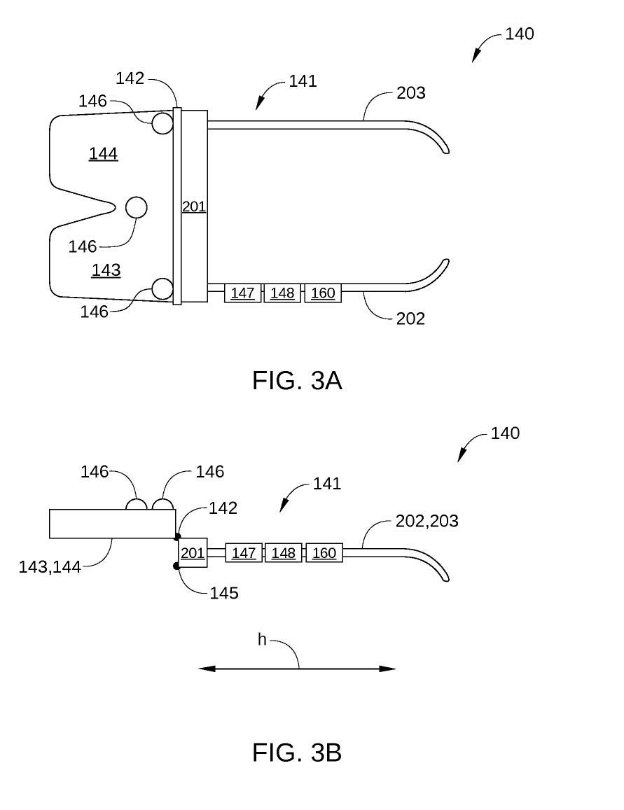

Hinge mechanism 142 allows left lens assembly 143 and right lens assembly 144 to switch between a 2D viewing orientation (shown in FIGS. 3A and 3B), in which a viewer looks directly at display device 110, and a 3D viewing orientation, in which the viewer looks at display device through left lens assembly 143 and right lens assembly 144. Hinge mechanism 142 may be configured to actuate in any technically feasible orientation or direction. In the embodiment illustrated in FIGS. 2A and 2B, hinge mechanism 142 allows left lens assembly 143 and right lens assembly 144 to move in unison and to swing upward and away from a viewers face in the 2D viewing orientation. In other embodiments, hinge mechanism 142 can allow left lens assembly 143 and right lens assembly 144 to move independently and, for example, swing sideways, i.e., outward and away from the vertical centerline of a viewer's face. In such embodiments, hinge mechanism 142 includes a separate mechanism for each of left lens assembly 143 and right lens assembly 144.

Hinge mechanism 142 may be configured as a passive hinge mechanism or an active mechanism. When hinge mechanism 142 is configured as a passive hinge mechanism, hinge mechanism 142 is generally actuated by a viewer manually, i.e., using a hand or finger, the viewer positions left lens assembly 143 and right lens assembly 144 in either the 2D viewing orientation or the 3D viewing orientation.

When hinge mechanism 142 is configured as an active hinge mechanism, left lens assembly 143 and right lens assembly 144 are positioned in either the 2D viewing orientation or the 3D viewing orientation by an automated actuator, such as a servo motor, a combination solenoid/spring mechanism, or the like. In such embodiments, hinge mechanism 142 may be configured to actuate from one viewing orientation to another viewing orientation in response to a viewer input, such as a hot key on a key board or a button on a television remote. Alternatively or additionally, hinge mechanism 142 may be configured to actuate from one viewing orientation to another viewing orientation in response to a viewer sending an input to controller 120 or display device 110 to change from one display mode (e.g., presenting 3D content) to a different display mode (e.g., presenting 2D content).

Alternatively or additionally, hinge mechanism 142 may be configured to actuate from one viewing orientation to another viewing orientation based on a change in the current display mode of stereoscopic display system 100, or on a signal received from controller 120 or display device 110 indicating that the current display mode is changing. For example, in the context of a 3D movie theater, such a signal may be transmitted to flip-up stereo viewing glasses 140 when presentation of 2D content has ended and the presentation of 3D content is about to begin. In such embodiments, the signal from controller 120 or display device 110 may be received via wireless communication module 160.

Left lens assembly 143 is configured to be transparent to a first image output by display device 110 and opaque to a second image output by display device 110, and right lens assembly 144 is configured to be transparent to the second image and opaque to the first image output. For example, the first image output may include the first half of the stereoscopic output of display device 110, e.g., an image of subject matter from a first viewpoint, while the second image output may include the second half of the stereoscopic output of display device 110, e.g., an image of the same subject matter from a second, slightly different viewpoint. Left lens assembly 143 and right lens assembly 144 may be implemented with any spectroscopic technology suitable for use with flip-up stereo viewing glasses 140 and display device 110, so that each of the viewer's eyes only sees a particular image output from display device 110. Suitable spectroscopic technologies include active polarization shutter systems, passive polarization systems, interference filter systems, color anaglyph systems, chromadepth systems, and the like. The specific technology employed in left lens assembly 143 and right lens assembly 144 of course depends on the technology employed in display device 110.

Sensor array 145 may be any technically feasible sensor configured to detect a current orientation of the left lens and the right lens. In some embodiments, sensor array 145 includes orientation markers 146, described below, that enable controller 120 and/or display device 110 to detect the current orientation of left lens assembly 143 and right lens assembly 144. In other embodiments, sensor array 145 includes one or more sensors that are coupled to hinge mechanism 142 and are configured to detect the position of left lens assembly 143 and right lens assembly 144.

In some embodiments, flip-up stereo viewing glasses 140 include orientation markers 146 positioned at various locations visible to orientation sensors 150 (shown in FIG. 1). Orientation markers 146 may be any technically feasible marker or position indicator, and enable controller 120 to determine the current orientation of left lens assembly 143 and right lens assembly 144 based on imaging input from orientation sensors 150. In such embodiments, controller 120 may be configured to change the current output state of display device 110 based on the current orientation of left lens assembly 143 and right lens assembly 144. Thus, when a viewer changes the orientation of left lens assembly 143 and right lens assembly 144 from a 3D viewing orientation to a 2D viewing orientation, controller 120 changes the display mode of display device 110 from presenting 3D content to presenting 2D content.

It is noted that orientation markers 146 can also indicate that a viewer would like to change to 2D viewing when the viewer has moved flip-up stereo viewing glasses 140 to any position significantly different than the standard position for viewing 3D content. For example, when a viewer moves flip-up stereo viewing glasses 140 to the top or back of the head, orientation sensors 150 can detect that flip-up stereo viewing glasses 140 are no longer positioned for the viewing of 3D content. Alternatively, in some embodiments flip-up stereo viewing glasses 140 may be free of orientation markers 146, but orientation sensors 150 and controller 120 may be configured to detect orientation of flip-up stereo viewing glasses 140 based on other imaging cues instead.

In some embodiments, flip-up stereo viewing glasses 140 include actuator controller 147 for controlling an automated actuator in hinge mechanism 142. Actuator controller 147 may be embedded in frame chassis 141 at any suitable location, and is coupled to power source 148 and, in some embodiments, to wireless communication module 160. Actuator controller 147 is configured to cause left lens assembly 143 and right lens assembly 144 to be switched from a first orientation (e.g., 2D viewing orientation) to a second orientation (e.g., 3D viewing orientation) and vice versa. For example, in some embodiments, actuator controller 147 causes such a change in orientation when a signal is received, via wireless communication module 160, from display device 110 or from controller 120. Actuator controller 147 may be any suitable processor implemented as a CPU, a GPU, an ASIC, an FPGA, or any other type of processing unit.

In embodiments in which flip-up stereo viewing glasses 140 includes one or more powered components, such as an automated actuator in hinge mechanism 142 or wireless communication module 160, flip-up stereo viewing glasses 140 also include power source 148. Power source 148 may include a self-contained source of electrical power, such as a batter embedded in frame chassis 141. Alternatively or additionally, power source 148 may include a wired connection to a power source remote from flip-up stereo viewing glasses 140.

When flip-up stereo viewing glasses 140 are in the 3D viewing orientation, left lens assembly 143 and right lens assembly 144 are positioned substantially perpendicular to the horizontal (h in FIG. 2B), and flip-up stereo viewing glasses 140 are generally worn on the face of a viewer positioned in viewing region 170 of display device 110 (shown in FIG. 1). Thus, with flip-up stereo viewing glasses 140 in the 3D viewing orientation and worn by a viewer of display device 110, the viewer can see and interact with 3D content presented by display device 110. For purposes of description, the horizontal h, shown in FIG. 2B, is assumed to be substantially perpendicular to a viewing surface of display device 110 in FIG. 1, but may have any relative orientation to other frames of reference. For example, if display device 110 is positioned on and substantially parallel to a vertical wall of a room, then horizontal h is perpendicular to the wall and parallel to the floor and ceiling of that room. By contrast, if display device 110 is positioned on and substantially parallel to a ceiling, then horizontal h is perpendicular to the ceiling and parallel to any vertical walls of the room.

FIG. 3A schematically illustrates a plan view of flip-up stereo viewing glasses 140 in a 2D viewing orientation, according to various embodiments of the present invention. FIG. 3B schematically illustrates a side view of flip-up stereo viewing glasses 140 in a 2D viewing orientation, according to various embodiments of the present invention. When flip-up stereo viewing glasses 140 are in the 2D viewing orientation, left lens assembly 143 and right lens assembly 144 are positioned substantially parallel with the horizontal h, so that the viewer can look directly at display device 110 without looking through left lens assembly 143 and right lens assembly 144. Alternatively, a viewer may completely remove flip-up stereo viewing glasses 140 or place flip-up stereo viewing glasses 140 on the crown of the head in order to stop viewing 3D content. In such embodiments, controller 120 can detect that flip-up stereo viewing glasses 140 are not positioned for 3D viewing, and can change the display mode of display device 110 from presenting 3D content to presenting 2D content.

In operation, flip-up stereo viewing glasses 140, as described herein, enable optimal use and enjoyment of stereoscopic display system 100. Because a viewer can easily change left lens assembly 143 and right lens assembly 144 from a 2D viewing orientation to a 3D viewing orientation, and vice versa, efficient switching between the viewing of 2D content and 3D content is facilitated. Specifically, the cumbersome and distracting necessity to completely remove or replace flip-up stereo viewing glasses 140 each time a viewer wants to change to a different display mode is avoided.

Furthermore, in some embodiments, changing the orientation of left lens assembly 143 and right lens assembly 144 from a 2D viewing orientation to a 3D viewing orientation and vice versa can be fully automated, so that a viewer can simply press a hot key to cause the change in viewing orientation. Alternatively or additionally, when a viewer performs an operation peculiar to 2D display mode (e.g., mouse movement), controller 120 receives this input and changes the display mode of display device 110 to 2D display mode. When the viewer performs an operation peculiar to 3D display mode (e.g., movement of a hand toward display device 110), controller 120 receives this input and changes the display mode of display device 110 to 3D display mode. In this way, interaction with various 2D and 3D content can be executed seamlessly and with little distraction to the viewer. For example, a viewer may be alternately performing 3D operations in a 3D modeling application and 2D operations in applications that are based on 2D content, such as when the viewer needs to briefly consult a spread sheet, word-processing document, or other 2D content.

Thus, the disclosed stereo-viewing glasses enable switching between viewing 2D content and 3D content without removal of the stereo-viewing glasses. In addition, communication between the stereo-viewing glasses and an associated stereoscopic display advantageously enables automatic switching of the display system between 2D or 3D display mode, based on the current orientation of the stereo-viewing glasses. Conversely, this communication can also enable automatic switching of the orientation of the stereo-viewing glasses from a 3D-viewing orientation to a 2D-viewing orientation based on the current display mode of the stereoscopic display.

In sum, embodiments of the present invention provide an apparatus and system for viewing a stereoscopic display. A left lens assembly and a right lens assembly are coupled to a frame chassis of stereo viewing glasses via a hinge assembly, which can be a passive or can include an actuator. The hinge mechanism allows the left lens assembly and the right lens assembly to switch from a 2D viewing orientation to a 3D viewing orientation. One advantage of the disclosed stereo-viewing glasses is that switching between viewing 2D content and 3D content can be effected without removal of the stereo-viewing glasses.

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

What is claimed is:

1. An apparatus for viewing a stereoscopic display, the apparatus comprising:
a frame chassis;
a hinge mechanism;
a left lens assembly coupled to the frame chassis via the hinge mechanism and configured to be transparent to a first image output by the stereoscopic display and opaque to a second image output from the stereoscopic display;
a right lens assembly coupled to the frame chassis via the hinge mechanism and configured to be transparent to the second image output and opaque to the first image output; and
a sensor array positioned to detect a current orientation of the left lens and the right lens,
wherein the hinge mechanism allows the left lens assembly and the right lens assembly to switch from a first orientation to a second orientation.

2. The apparatus of claim 1, wherein the first orientation comprises an orientation for viewing two-dimensional content presented by the stereoscopic display, and the second orientation comprises an orientation for viewing three-dimensional content presented by the stereoscopic display

3. The apparatus of claim 1, wherein the first image output comprises a first portion of stereoscopic output generated by the stereoscopic display, and the second image output comprises a second portion of stereoscopic output generated by the stereoscopic display.

4. The apparatus of claim 1, wherein the sensor array is coupled to the hinge mechanism and is configured to generate a signal based on the current orientation of the left lens and the right lens.

5. The apparatus of claim 1, wherein the sensor array includes an orientation marker mounted on at least one of the left lens array and the right lens array.

6. The apparatus of claim 1, wherein the hinge mechanism comprises an automated actuator configured to switch the left lens assembly and the right lens assembly from the first orientation to the second orientation.

7. The apparatus of claim 6, further comprising:
a wireless communication module configured to transmit information to and receive information from the stereoscopic display; and
a controller configured to cause the left lens assembly and the right lens assembly to be switched from the first orientation to the second orientation in response to the wireless communication module receiving a signal from the stereoscopic display.

8. The apparatus of claim 1, further comprising a wireless communication module configured to transmit information to and receive information from the stereoscopic display.

9. The apparatus of claim 8, further comprising a controller configured to cause a signal to be transmitted to the stereoscopic display when the left lens assembly and the right lens assembly are switched from the first orientation to the second orientation.

10. A stereoscopic display system comprising:
a stereoscopic display configured to present a first image output and a second image output; and
an apparatus for viewing the stereoscopic display, the apparatus comprising:
a frame chassis;
a hinge mechanism;
a left lens assembly coupled to the frame chassis via the hinge mechanism and configured to be transparent to the first image output and opaque to the second image;
a right lens assembly coupled to the frame chassis via the hinge mechanism and configured to be transparent to the second image output and opaque to the first image output; and
a sensor array positioned to detect a current orientation of the left lens and the right lens,
wherein the hinge mechanism allows the left lens assembly and the right lens assembly to switch from a first orientation to a second orientation.

11. The stereoscopic display system of claim 1, wherein the first orientation comprises an orientation for viewing two-dimensional content presented by the stereoscopic display and the second orientation comprises an orientation for viewing three-dimensional content presented by the stereoscopic display.

12. The stereoscopic display system of claim 1, wherein the sensor array includes an orientation marker mounted on at least one of the left lens array and the right lens array.

13. The stereoscopic display system of claim 12, further comprising a sensor configured to generate an image of the orientation marker when the apparatus is positioned for viewing the stereoscopic display.

14. The stereoscopic display system of claim 13, further comprising a controller configured to determine an orientation of the left lens assembly and the right lens assembly based on the image of the orientation marker.

15. The stereoscopic display system of claim 14, wherein the controller is further configured to change a display mode of the stereoscopic display based on the orientation of the left lens assembly and the right lens assembly.

16. The stereoscopic display system of claim 10, wherein the hinge mechanism comprises an automated actuator configured to switch the left lens assembly and the right lens assembly from the first orientation to the second orientation.

17. The stereoscopic display system of claim 16, wherein the apparatus further comprises:
a wireless communication module configured to transmit information to and receive information from the stereoscopic display; and
an actuator controller configured to cause the left lens assembly and the right lens assembly to be switched from the first orientation to the second orientation in response to the wireless communication module receiving a signal from the stereoscopic display.

18. The stereoscopic display system of claim 10, further comprising a wireless communication module configured to transmit information to and receive information from the stereoscopic display.

19. The stereoscopic display system of claim 18, further comprising a controller configured to cause a signal to be transmitted to the stereoscopic display when the left lens assembly and the right lens assembly are switched from the first orientation to the second orientation.

20. The stereoscopic display system of claim 10, wherein the first image output comprises a first portion of stereoscopic output generated by the stereoscopic display, and the second image output comprises a second portion of stereoscopic output generated by the stereoscopic display.
